(19) United States
(12) Patent Application Publication
(10) Pub. No.: US 2012/0133962 A1
(43) Pub. Date: May 31, 2012

(54) CALIBRATION SYSTEM, CALIBRATION METHOD, AND RECORDING MEDIUM THAT STORES PROGRAM

(75) Inventor: Katsuji Kondo, Hino-shi (JP)

(73) Assignee: Konica Minolta Business Technologies, Inc., Chiyoda-ku (JP)

(21) Appl. No.: 13/297,307

(22) Filed: Nov. 16, 2011

(30) Foreign Application Priority Data
Nov. 30, 2010 (JP) 2010-265866

(51) Int. Cl. H04N 1/60

(52) U.S. Cl. 358/1.9

(57) ABSTRACT

A calibration system including: an image forming unit that outputs a chart including patches corresponding to input CMY values of tertiary and secondary colors; a color measuring unit that measures patch colors and outputs colorimetric values; and a control unit that sets a target profile correlating the input CMY values of the tertiary and secondary colors with target color values; inputs the colorimetric values; calculates differences between the input colorimetric values and the target color values; acquires corrected CMY values relative to the input CMY values of the tertiary and secondary colors; acquires first and second color components based on the corrected CMY values of the tertiary and secondary colors, respectively; calculates output CMY values of a primary color through weighted averaging of the first and second color components; and generates a primary color correction table to determine the output CMY values relative to the input CMY values.

### BACKGROUND OF THE INVENTION

1. Field of the Invention

The present invention relates to a calibration system, a calibration method, and a recording medium that stores a program.

2. Description of Related Art

In recent years, on-demand printers (image forming apparatuses, such as electrophotographic printers and ink-jet printers) have been widely used in the color printing business. In order to maintain the output quality of such image forming apparatuses, calibration has become more important than ever to control color tone.

A known method is to use an output curve for correcting a primary color composed of one of the reference colors of cyan, magenta, and yellow (CMY) to correct a variation in output color of an image forming apparatus. The method, however, cannot sufficiently correct a variety of color tones of images in secondary and tertiary colors composed of multiple colors of CMY.

In view of such circumstances, Japanese Patent No. 4207611 discloses a method of color correction using a multidimensional look-up table (LUT), such as a three-dimensional or four-dimensional LUT, as a conventional calibration method.

Using such a multidimensional LUT appropriately corrects a variety of color tones of images, including secondary and tertiary colors. The method, however, requires calculation for correction with reference to the multidimensional LUT for every image output, thus resulting in a heavy calculation load for correction. In addition, changing sheets used for output and target color tones during continuous output further increase a processing load.

In order to prevent an increase in processing load and to achieve correction that covers a variety of color tones of images, Japanese Unexamined Patent Application Publication No. 2008-288722 discloses, for example, a method of adjusting a gamma correction parameter for each primary ink color to adjust a gray tone such that a shade of gray, which is a tertiary color provided by outputting a mixture of multiple primary ink colors, matches a target.

The method disclosed in Japanese Unexamined Patent Application Publication No. 2008-288722 adjusts colors using a primary color curve, thus preventing an increase in processing load. Due to single color correction applied for correcting a gray tone, however, no secondary colors are taken into consideration and thus the correction cannot be sufficiently performed in some situations.

### SUMMARY OF THE INVENTION

In view of the circumstances above, an object of the present invention is to provide a calibration system that performs primary color correction without an increase in processing load and that concurrently performs correction in consideration of both secondary and tertiary colors, a calibration method, and a program.

According to a first aspect of the present invention, there is provided a calibration system including: an image forming unit that forms a color image; and outputs a chart including a first patch corresponding to input CMY values of a tertiary color and a second patch corresponding to input CMY values of a secondary color, each of the tertiary color and the secondary color composed of a combination of CMY reference colors; a color measuring unit that measures colors of the first and second patches in the chart output from the image forming unit and outputs colorimetric values in a colorimetric color space; and a control unit that sets a target profile correlating a combination of the input CMY values of the tertiary color and a combination of the input CMY values of the secondary color input to the image forming unit, with respective target color values in the colorimetric color space; inputs the colorimetric values from the color measuring unit; calculates differences between the input colorimetric values and the respective target color values in the target profile; acquires, based on the calculated differences, corrected CMY values of the tertiary color relative to the input CMY values of the tertiary color and corrected CMY values of the secondary color relative to the input CMY values of the secondary color, using the target profile; acquires a first color component for a reference color based on the corrected CMY values of the tertiary color and a second color component for the reference color based on the corrected CMY values of the secondary color; calculates output CMY values of a primary color through predetermined weighted averaging of the acquired first color component and the acquired second color component, for each of the reference colors; and generates, based on the calculated output CMY values of the primary color, a primary color correction table with which the input CMY values are corrected for each of the reference colors to determine the output CMY values relative to the input CMY values, wherein the image forming unit forms the color image based on the output CMY values determined by correcting the input CMY values using the primary color correction table generated by the control unit.

According to a second aspect of the present invention, there is provided a calibration method using an image forming apparatus that forms a color image, the method including: (a) outputting, from the image forming apparatus, a chart including a first patch corresponding to input CMY values of a tertiary color and a second patch corresponding to input CMY values of a secondary color, each of the tertiary color and the secondary color composed of a combination of CMY reference colors; and measuring colors of the output first and second patches in the chart and acquiring colorimetric values in a colorimetric color space; (b) setting a target profile correlating a combination of the input CMY values of the tertiary color and a combination of the input CMY values of the secondary color input to the image forming apparatus, with respective target color values in the colorimetric color space; (c) calculating differences between the colorimetric values acquired in step (a) and the respective target color values in the target profile; and acquiring, based on the calculated differences, corrected CMY values of the tertiary color relative to the input CMY values of the tertiary color and corrected CMY values of the secondary color relative to the input CMY values of the secondary color, using the target profile; (d) acquiring a first color component for a reference color based on the corrected CMY values of the tertiary color and a second color component for the reference color based on the corrected CMY values of the secondary color; and calculating output CMY values of a primary color through predetermined weighted averaging of the acquired first color component and the acquired second color component, for each of the reference colors; (e) generating, based on the output CMY values of the primary color acquired in step (d), a primary color correction table with which the input CMY values are corrected for each of the reference colors to determine the output CMY values relative to the input CMY values; and (f) forming the color image in the image forming apparatus based on the output CMY values determined by correcting the input CMY values using the primary color correction table.

According to a third aspect of the present invention, there is provided a recording medium that stores a program to cause a computer to function as: an image forming unit that forms a color image; and outputs a chart including a first patch corresponding to input CMY values of a tertiary color and a second patch corresponding to input CMY values of a secondary color, each of the tertiary color and the secondary color composed of a combination of CMY reference colors; a color measuring unit that measures colors of the first and second patches in the chart output from the image forming unit and outputs colorimetric values in a colorimetric color space; and a control unit that sets a target profile correlating a combination of the input CMY values of the tertiary color and a combination of the input CMY values of the secondary color input to the image forming unit, with respective target color values in the colorimetric color space; inputs the colorimetric values from the color measuring unit; calculates differences between the input colorimetric values and the respective target color values in the target profile; acquires, based on the calculated differences, corrected CMY values of the tertiary color relative to the input CMY values of the tertiary color and corrected CMY values of the secondary color relative to the input CMY values of the secondary color, using the target profile; acquires a first color component for a reference color based on the corrected CMY values of the tertiary color and a second color component for the reference color based on the corrected CMY values of the secondary color; calculates output CMY values of a primary color through predetermined weighted averaging of the acquired first color component and the acquired second color component, for each of the reference colors; and generates, based on the calculated output CMY values of the primary color, a primary color correction table with which the input CMY values are corrected for each of the reference colors to determine the output CMY values relative to the input CMY values, wherein the image forming unit forms the color image based on the output CMY values determined by correcting the input CMY values using the primary color correction table generated by the control unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 illustrates a system configuration of a print system according to an embodiment;

FIG. 2 is a block diagram illustrating a functional configuration of a calibration device;

FIG. 3 is a block diagram illustrating a functional configuration of a print instruction terminal;

FIG. 4 is a block diagram illustrating a functional configuration of a controller;

FIG. 5 is a flowchart illustrating a procedure of generating a calibration curve;

FIG. 6A illustrates CMYK values corresponding to output color patches;

FIG. 6B illustrates CMYK values corresponding to output color patches;

FIG. 7 is a flowchart illustrating a process of generating a calibration curve;

FIG. 8 is a flowchart illustrating a process of calculating a tertiary color correction target;

FIG. 9 is a flowchart illustrating a process of calculating a secondary color correction target;

FIG. 10 illustrates setting of a current target;

FIG. 11A illustrates a primary color calibration curve;

FIG. 11B illustrates a primary color calibration curve;

FIG. 11C illustrates a primary color calibration curve; and

FIG. 12 illustrates setting of a current target.

### DESCRIPTION OF THE PREFERRED EMBODIMENTS

A print system involving calibration according to an embodiment of the present invention is described below with reference to the attached drawings. The scope of the present invention, however, is not limited to the embodiment. In the description below, components having the same functions and configurations are denoted with the same reference numerals, and descriptions of such components are omitted.

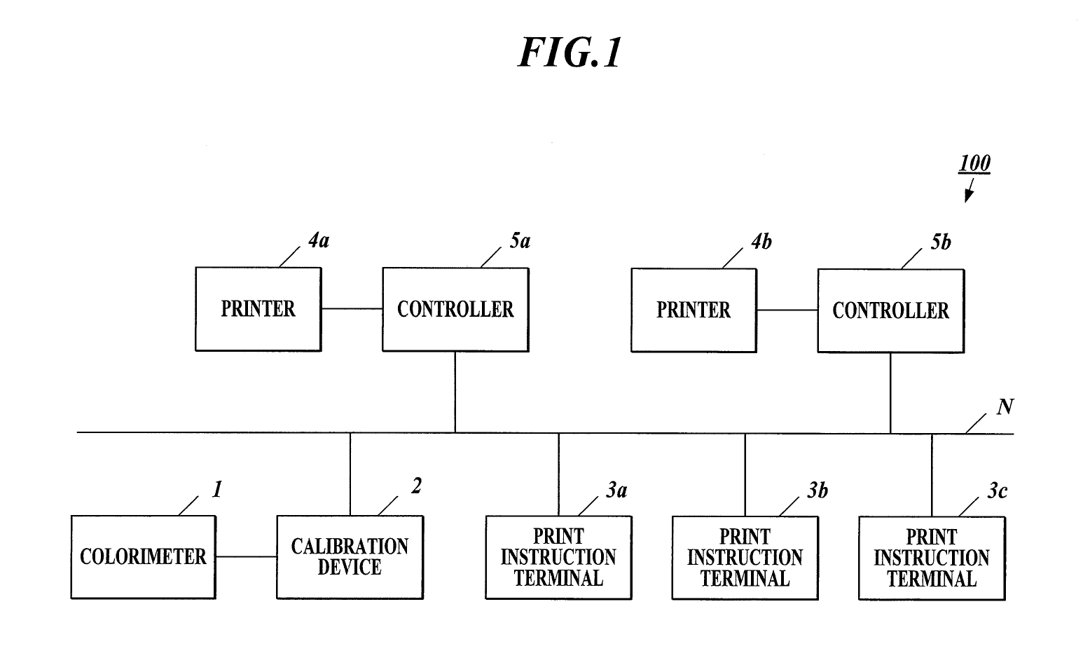

FIG. 1 illustrates a system configuration of a print system 100. As shown in FIG. 1, the print system 100 includes, for example, a colorimeter 1; a calibration device 2; print instruction terminals 3a, 3b, and 3c; printers 4a and 4b; and controllers 5a and 5b. The calibration device 2, the print instruction terminals 3a, 3b, and 3c, and the controllers 5a and 5b are connected to one another through a communication network N, such as an intranet, for data communication.

The colorimeter 1 measures color patches in a plurality of colors included in a color chart output from each of the printers 4a and 4b and generates colorimetric data. The colorimetric data are represented by a color system independent of a device, such as L*a*b* or XYZ. An X-Rite i1-Pro, for example, is used as the colorimeter 1 in the embodiment, but a different colorimeter may be used. The colorimeter 1 may be built into each of the printers 4a and 4b such that color measurement is performed while a color chart is being delivered during its output.

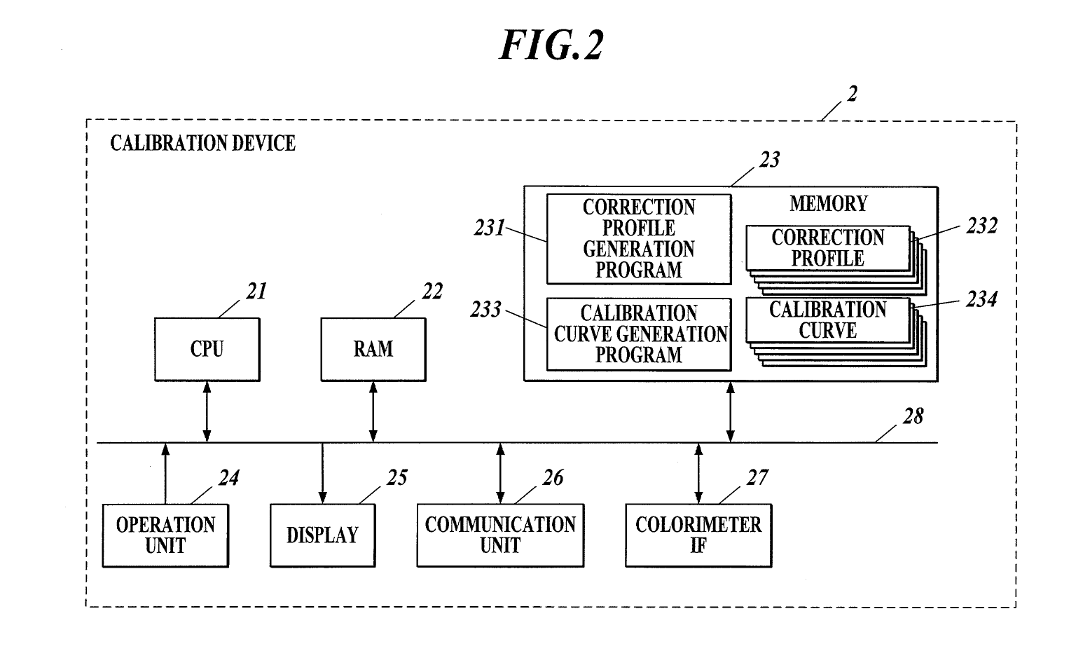

The calibration device 2, which is composed of a general-purpose PC (personal computer), is an information processing device that generates a calibration curve 234 (refer to FIG. 2) to be used in the controllers 5a and 5b. The calibration device 2 instructs each of the controllers 5a and 5b to output a color chart. In addition, the calibration device 2 acquires the colorimetric data of the color chart from the colorimeter 1. Based on the acquired colorimetric data, the calibration device 2 executes a calibration curve generation program 233 and generates and stores the calibration curve 234. The calibration device 2 transmits the calibration curve 234 to each of the controllers 5a and 5b so as to store the calibration curve 234 in each of the controllers 5a and 5b.

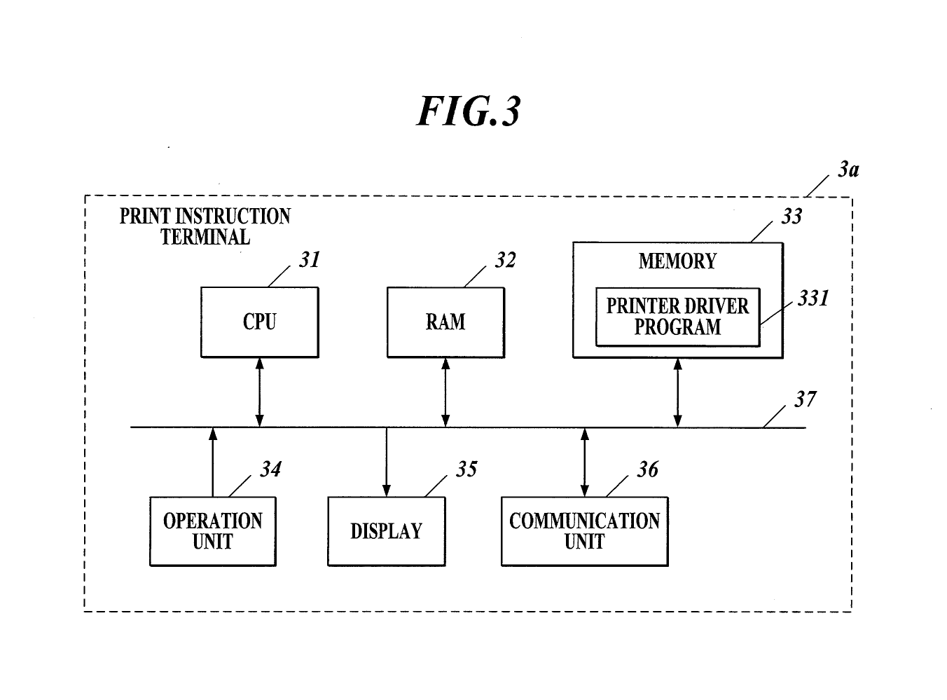

The print instruction terminals 3a, 3b, and 3c, each of which is composed of a general-purpose PC, are information processing devices that provide print instructions to the printers 4a and 4b through the controllers 5a and 5b, respectively. The print instruction terminals 3a, 3b, and 3c are each loaded with a printer driver program 331 (refer to FIG. 3) that provides a print instruction and specifies a print procedure. The print instruction terminals 3a, 3b, and 3c may provide a print instruction through a print control program or by copying a file to a designated hot folder.

The printers 4a and 4b each process printing using a specified sheet type and tray on the basis of raster data received from the controllers 5a and 5b, respectively.

The controllers 5a and 5b, each of which is composed of a general-purpose PC, are information processing devices that perform various processes such as color conversion, rasterization, and screening on print data received from the print instruction terminals 3a, 3b, and 3c; and that generate raster data. The controllers 5a and 5b transmit the raster data to the printers 4a and 4b, respectively.

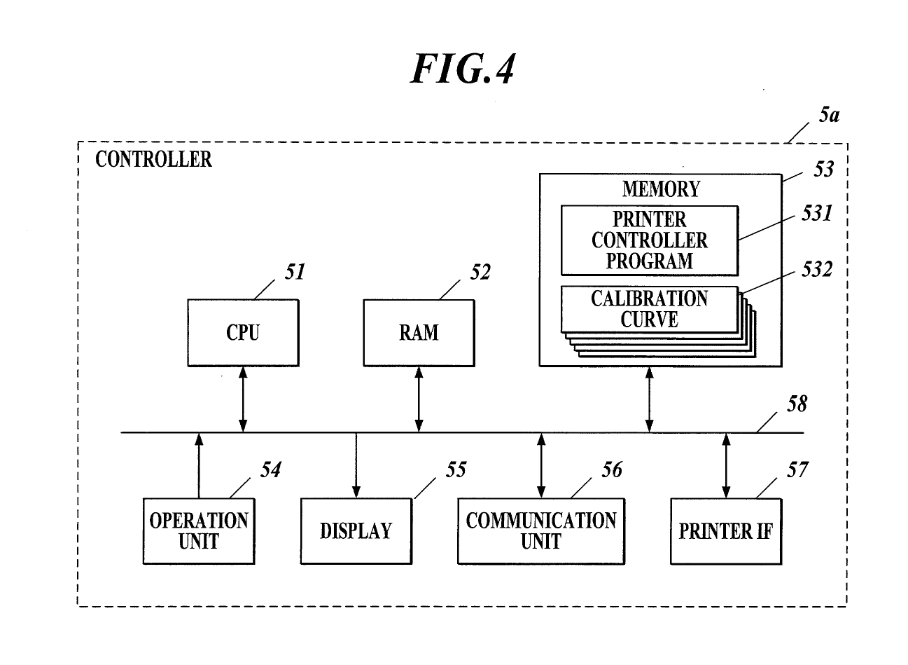

The controllers 5a and 5b each store a calibration curve 532 (refer to FIG. 4) as a color conversion table.

The calibration curve 532 is a one-dimensional table for converting input CMYK values for every reference color.

FIG. 2 illustrates a functional configuration of the calibration device 2. As shown in FIG. 2, the calibration device 2 includes, for example, a CPU (central processing unit) 21, a RAM (random access memory) 22, a memory 23, an operation unit 24, a display 25, a communication unit 26, and a colorimeter IF (interface) 27. These components are connected to one another through a bus 28.

The CPU 21 comprehensively controls processing operations in the components of the calibration device 2. In response to operation signals input from the operation unit 24 or instruction signals received through the communication unit 26, the CPU 21 reads out a variety of processing programs stored in the memory 23 and loads them in the RAM 22, and then executes a variety of processes in collaboration with the programs.

The RAM 22 provides a work area that temporarily stores these processing programs executed by the CPU 21 and data associated with the programs.

The memory 23, which is composed of a storage device such as a non-volatile semiconductor memory or a hard disk drive, stores a variety of processing programs and data associated with various processes. The memory 23 stores, for example, a correction profile generation program 231, a correction profile 232, the calibration curve generation program 233, and the calibration curve 234.

The operation unit 24 includes a keyboard composed of cursor keys, character keys, and a variety of function keys; and a pointing device, such as a mouse. The operation unit 24 receives operation input by a user. The operation unit 24 outputs, to the CPU 21, operation signals input through keyboard operation or mouse operation.

The display 25 has an LCD (liquid crystal display) and displays a variety of operation screens and a variety of results of processing in accordance with instructions from the CPU 21.

The communication unit 26 transmits and receives data to and from an external device through the communication network N. The communication unit 26 transmits, for example, the calibration curve 234 to the controllers 5a and 5b.

The colorimeter IF 27 inputs and outputs data from and to the colorimeter 1. The colorimeter IF 27 receives the colorimetric data from the colorimeter 1.

The CPU 21 executes the correction profile generation program 231 and generates the correction profile 232. The correction profile 232 indicates a relationship between L*a*b* values and CMY values and includes a “CMY-L*a*b* LUT (look-up table)” for determining the L*a*b* values from the CMY values and an “L*a*b*-CMY LUT” for determining the CMY values from the L*a*b* values. The LUTs can be generated in a procedure similar to a procedure of generating a general ICC (International Color Consortium) profile. In a method of generating a “CMYK-L*a*b* LUT” and an “L*a*b*-CMYK LUT” disclosed in Japanese Unexamined Patent Application Publication No. 2004-356952, for example, replacing all K values with 0% can provide a desired LUT.

In the embodiment, the correction profile 232 is generated based on a device profile corresponding to each of the printers 4a and 4b.

The device profile indicates a relationship between L*a*b* values and CMYK values in a predetermined reference state of each of the printers 4a and 4b. The device profile includes a “CMYK-L*a*b* LUT” for determining the L*a*b* values from the CMYK values and an “L*a*b*-CMYK LUT” for determining the CMYK values from the L*a*b* values. A device profile may be used which is generated in advance by a manufacturer and stored in a predetermined recording medium. Alternatively, a user may generate any profile. An external device profile may also be downloaded through a network.

The CPU 21 first generates the “CMY-L*a*b* LUT” of the correction profile 232 from the “CMYK-L*a*b* LUT” included in the device profile. Specifically, the “CMY-L*a*b* LUT” is generated by extracting only CMYK values having a K value of 0% from the “CMYK-L*a*b* LUT” of the device profile and generating an LUT using the extracted values. Subsequently, the CPU 21 generates the “L*a*b*-CMY LUT” based on the generated “CMY-L*a*b* LUT.” This “L*a*b*-CMY LUT” can be generated by determining the respective CMY values corresponding to L*a*b*: 33×33×33 points in convergence calculation and generating an LUT using the determined values, as explained in detail in Japanese Unexamined Patent Application Publication No. 2004-356952. At this time, for L*a*b* values outside of a color gamut represented by CMY, CMY values can be determined by mapping (gamut mapping) the L*a*b* values so as to fall within the color gamut and then performing convergence calculation.

The CPU 21 stores, in the memory 23, the correction profile 232 determined as above.

In the embodiment, only one correction profile 232 is described. It is also possible to prepare a plurality of correction profiles 232 that correspond to, for example, a plurality of types of object information including texts, graphics, and images; and a plurality of methods of color matching using “color measurement,” “perception,” and “saturation.” The object information is described in a PDL (page description language) included in the print data transmitted from the print instruction terminals 3a, 3b, and 3c.

The CPU 21 instructs each of the controllers 5a and 5b to output a color chart for calibration (calibration chart) through the communication unit 26. Specifically, the CPU 21 transmits to each of the controllers 5a and 5b a print instruction that includes image data of a color chart in which color patches of respective CMYK values are arranged.

The CPU 21 controls the colorimeter 1 through the colorimeter IF 27 and instructs color measurement of the calibration chart output from each of the printers 4a and 4b (output device). The CPU 21 acquires, from the colorimeter 1 through the color measure IF 27, colorimetric data obtained through the color measurement of the color chart by the colorimeter 1.

Based on the colorimetric data acquired from the colorimeter 1, the CPU 21 generates the calibration curve 234 and stores the calibration curve 234 in the memory 23. A method of generating the calibration curve 234 is described hereinafter.

The CPU 21 transmits the calibration curve 234 to each of the controllers 5a and 5b connected to the printers 4a and 4b, respectively, from which the color chart is output. Then, the CPU 21 registers the calibration curve 234 in each of the controllers 5a and 5b.

FIG. 3 illustrates a functional configuration of the print instruction terminal 3a. As shown in FIG. 3, the print instruction terminal 3a includes, for example, a CPU 31, a RAM 32, a memory 33, an operation unit 34, a display 35, and a communication unit 36. These components are connected to one another through a bus 37.

The CPU 31 comprehensively controls processing operations in the components of the print instruction terminal 3a. In response to operation signals input from the operation unit 34 or instruction signals received through the communication unit 36, the CPU 31 reads out a variety of processing programs stored in the memory 33 and loads them in the RAM 32, and then executes a variety of processes in collaboration with the programs.

The RAM 32 provides a work area that temporarily stores these processing programs executed by the CPU 31 and data associated with the programs.

The memory 33, which is composed of a storage device such as a non-volatile semiconductor memory or a hard disk drive, stores a variety of processing programs and data associated with various processes. The memory 33 stores, for example, a printer driver program 331.

The operation unit 34 includes a keyboard composed of cursor keys, character keys, and a variety of function keys; and a pointing device, such as a mouse. The operation unit 34 receives operation input by a user. The operation unit 34 outputs, to the CPU 31, operation signals input through keyboard operation or mouse operation.

The display 35 has an LCD and displays a variety of operation screens and a variety of results of processing in accordance with instructions from the CPU 31.

The communication unit 36 transmits and receives data to and from an external device through the communication network N. The communication unit 36 transmits, for example, print data to the controllers 5a and 5b.

To provide a print instruction to the controllers 5a and 5b, the CPU 31 generates print data and transmits the print data to the controllers 5a and 5b through the communication unit 36.

The print data include image data that indicate print contents and print setting information.

The print instruction terminals 3b and 3c each have the same configuration as that of the print instruction terminal 3a. Thus, FIG. 3 is used as a substitute, and illustration and explanation of the configuration are omitted.

FIG. 4 illustrates a functional configuration of the controller 5a. As shown in FIG. 4, the controller 5a includes, for example, a CPU 51, a RAM 52, a memory 53, an operation unit 54, a display 55, a communication unit 56, and a printer IF 57. These components are connected to one another through a bus 58.

The CPU 51 comprehensively controls processing operations in the components of the controller 5a. In response to operation signals input from the operation unit 54 or instruction signals received through the communication unit 56, the CPU 51 reads out a variety of processing programs stored in the memory 53 and loads them in the RAM 52, and then executes a variety of processes in collaboration with the programs.

The RAM 52 provides a work area that temporarily stores these processing programs executed by the CPU 51 and data associated with the programs.

The memory 53, which is composed of a storage device such as a non-volatile semiconductor memory or a hard disk drive, stores a variety of processing programs and data associated with various processes. The memory 53 stores, for example, a printer controller program 531 and a calibration curve 532. The calibration curve 532 corresponds to the calibration curve 234 generated by the calibration device 2.

The operation unit 54 includes a keyboard composed of cursor keys, character keys, and a variety of function keys; and a pointing device, such as a mouse. The operation unit 54 receives operation input by a user. The operation unit 54 outputs, to the CPU 51, operation signals input through keyboard operation or mouse operation.

The display 55 has an LCD and displays a variety of operation screens and a variety of results of processing in accordance with instructions from the CPU 51.

The communication unit 56 transmits and receives data to and from an external device through the communication network N. The communication unit 56 receives, for example, the calibration curve 234 from the calibration device 2. The communication unit 56 also receives the print data from the print instruction terminals 3a, 3b, and 3c.

The printer IF 57 inputs and outputs data from and to the printer 4a. The printer IF 57 transmits raster data to the printer 4a.

The CPU 51 receives the print data from the print instruction terminals 3a, 3b, and 3c through the communication unit 56.

The CPU 51 reads out the calibration curve 532 stored in the memory 53 and writes it into the RAM 52. In the case where a plurality of calibration curves 532 are stored in the memory 53, the CPU 51 selects, for example, a calibration curve 532 that corresponds to the print setting information included in the print data transmitted from the print instruction terminals 3a, 3b, and 3c; and writes the selected calibration curve 532 into the RAM 52.

In collaboration with a color conversion program, the CPU 51 performs color conversion using the calibration curve 532 written in the RAM 52.

The CPU 51 performs RIP (raster image processing) on image data having undergone the color conversion and generates raster data. The CPU 51 then transmits the raster data to the printer 4a through the printer IF 57.

The controller 5b has the same configuration as that of the controller 5a. Thus, FIG. 4 is used as a substitute, and illustration and explanation of the configuration are omitted.

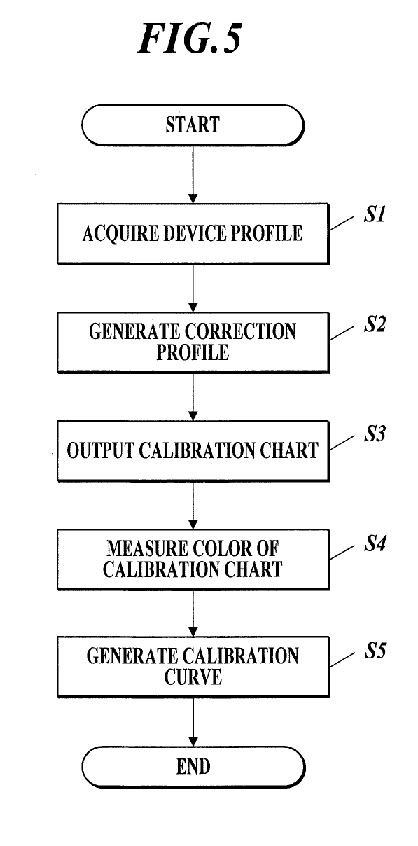

A procedure of generating a calibration curve using the print system 100 having the configuration above is described below with reference to FIG. 5.

First, a CPU 21 of a calibration device 2 acquires a device profile which serves as a reference for generating a correction profile 232 (Step S1). Subsequently, the CPU 21 of the calibration device 2 generates the correction profile 232 on the basis of the acquired device profile in the procedure described above (Step S2). Then, the calibration device 2 instructs each of controllers 5a and 5b to output a calibration chart from the printers 4a and 4b, respectively (Step S3).

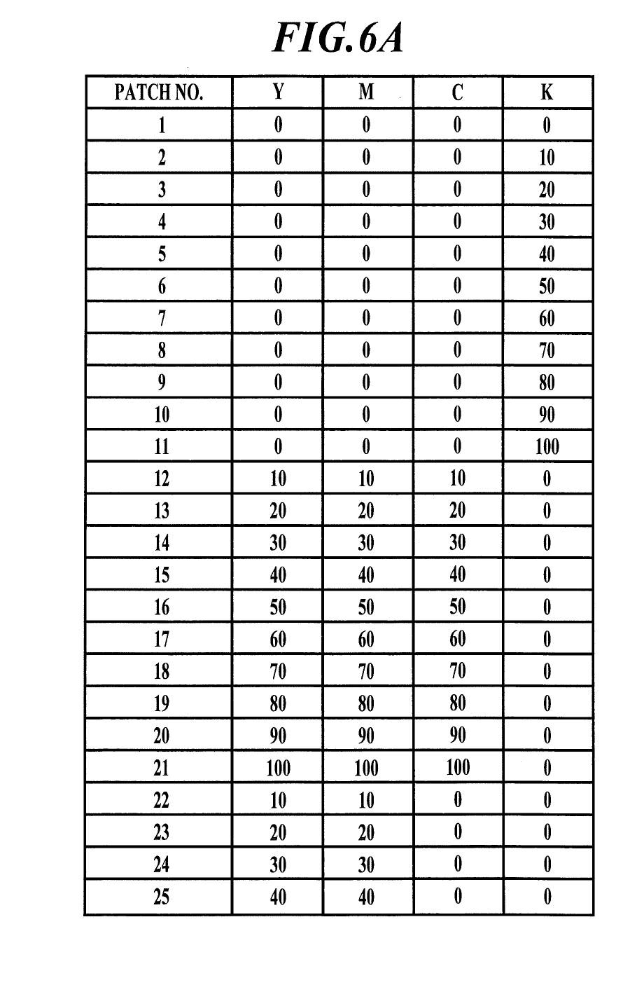

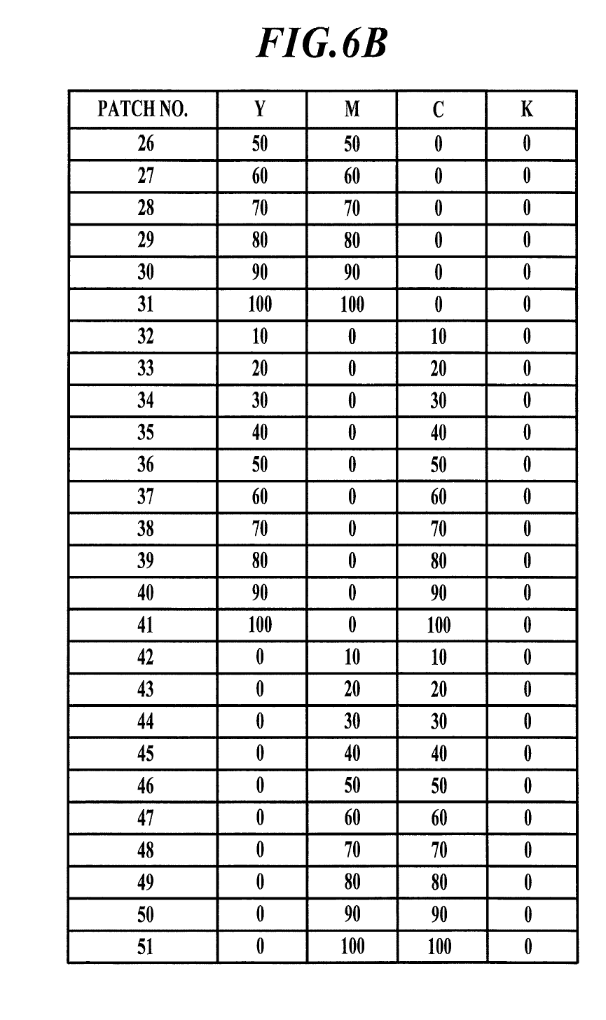

The calibration chart output from each of the printers 4a and 4b is described below with reference to FIGS. 6A and 6B.

The calibration chart of the embodiment has a variety of color patches, including tertiary color patches each composed of three CMY colors, secondary color patches each composed of two of the CMY colors, and K color patches composed of a single K color.

The tertiary color patches include color patches having component values of 10%, 20%, 30%, 40%, 50%, 60%, 70%, 80%, 90%, and 100% for each of the CMY colors. The tertiary color patches correspond to patch Nos. 12 to 21 shown in FIG. 6A.

The secondary color patches include R (red) color patches each composed of a combination of M (magenta) and Y (yellow), G (green) color patches each composed of a combination of C (cyan) and Y, and B (blue) color patches each composed of a combination of C and M.

The R color patches include color patches having component values of 10%, 20%, 30%, 40%, 50%, 60%, 70%, 80%, 90%, and 100% for each of the MY colors. The R color patches correspond to patch Nos. 22 to 31 shown in FIGS. 6A and 6B.

The G color patches include color patches having component values of 10%, 20%, 30%, 40%, 50%, 60%, 70%, 80%, 90%, and 100% for each of the CY colors. The G color patches correspond to patch Nos. 32 to 41 shown in FIG. 6B.

The B color patches include color patches having component values of 10%, 20%, 30%, 40%, 50%, 60%, 70%, 80%, 90%, and 100% for each of the CM colors. The B color patches correspond to patch Nos. 42 to 51 shown in FIG. 6B.

The K color patches include color patches having component values of 0%, 10%, 20%, 30%, 40%, 50%, 60%, 70%, 80%, 90%, and 100% for K (black). The K color patches correspond to patch Nos. 1 to 11 shown in FIG. 6A.

The color patches included in the calibration color chart shown in FIGS. 6A and 6B are provided merely for exemplary purposes and are not for limitation.

The CPU 21 of the calibration device 2 instructs a colorimeter 1 to measure colors in the output calibration chart (Step S4). Specifically, the CPU 21 instructs the colorimeter 1 to measure the color of each of the color patches in the calibration chart composed as above and causes the calibration device 2 to output the corresponding L*a*b* values.

Then, the CPU 21 of the calibration device 2 generates a primary color calibration curve for each of the CMYK colors (Step S5). The CPU 21 compares acquired L*a*b* values with the “CMY-L*a*b* LUT” of the correction profile 232 to determine color differences (errors)) at respective color measurement points, and then determines CMY values after correction (corrected CMY values) based on the color differences (detailed procedure will be described below). Subsequently, the CPU 21 generates correction curves with which corrected CMY values are determined relative to input CMY values for the respective tertiary colors and secondary colors of RGB. The CPU 21 then integrates the correction curves through predetermined weighted averaging, and generates the primary color calibration curve for each of the CMY colors. Furthermore, the CPU 21 generates a K correction calibration curve with which corrected K values are determined relative to input K values, as is described below.

The calibration curves generated in such a procedure can achieve primary color correction that takes into consideration the secondary and tertiary colors and results in excellent color reproducibility.

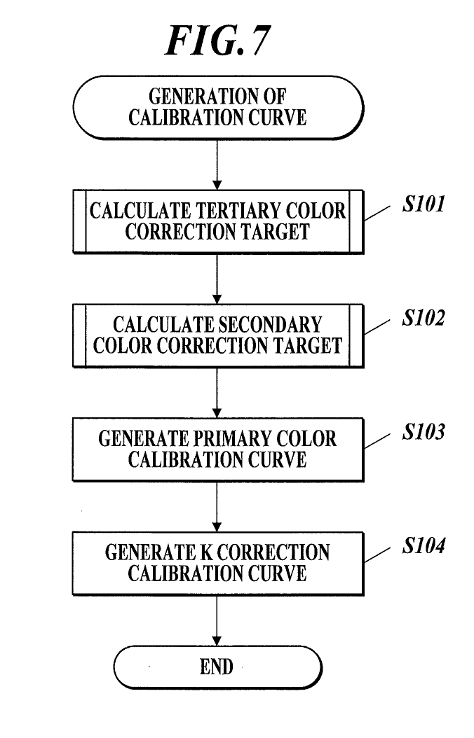

In Step S5 of the procedure of generating the calibration curve shown in FIG. 5, a process of generating the calibration curve executed by the CPU 21 of the calibration device 2 is described below with reference to FIG. 7.

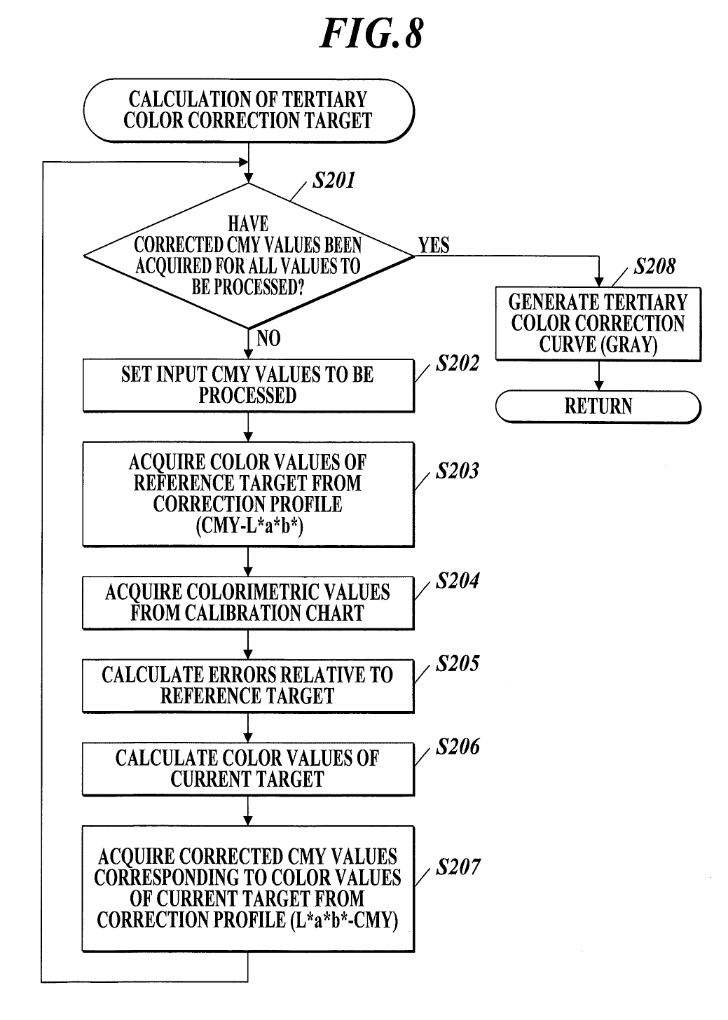

First, the CPU 21 of the calibration device 2 calculates a tertiary color correction target (Step S101). The process of calculating the tertiary color correction target is described below with reference to FIG. 8.

The CPU 21 determines whether all corrected CMY values of the tertiary colors have been acquired (Step S201). Specifically, the CPU 21 determines whether the corrected CMY values have been acquired for tertiary colors to be measured whose CMY component values are 0%, 10%, 20%, 30%, 40%, 50%, 60%, 70%, 80%, 90%, and 100%.

If the CPU 21 determines that not all the corrected CMY values of the tertiary colors have been acquired (Step S201: N), the CPU 21 sets input CMY values to be processed (Step S202). Specifically, among tertiary colors to be measured whose CMY component values are 0%, 10%, 20%, 30%, 40%, 50%, 60%, 70%, 80%, 90%, and 100%, the CPU 21 sets any CMY values for which no corresponding corrected CMY values are provided as values to be processed.

Referring to a “CMY-L*a*b* LUT” of the correction profile 232, the CPU 21 then acquires L*a*b* values corresponding to the input CMY values as color values of a reference target (Step S203). Based on the colorimetric values obtained through color measurement of the calibration chart as above, the CPU 21 acquires colorimetric values (L*a*b* values) corresponding to the input CMY values (Step S204).

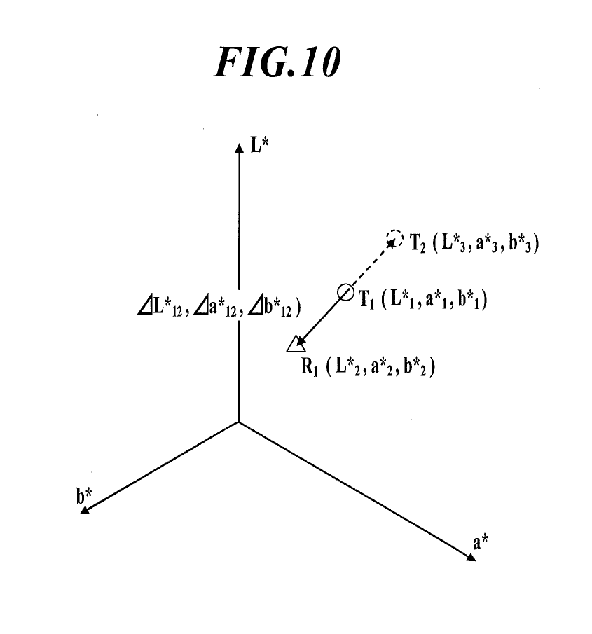

Subsequently, the CPU 21 calculates errors of the colorimetric values relative to the color values of the reference target (Step S205). Specifically, the CPU 21 determines color differences (ΔL*a*b*) between the L*a*b* values as the color values of the reference target and the respective L*a*b* values acquired in Step S204 to calculate the errors of the colorimetric values. As shown in FIG. 10, for instance, in the case where L*a*b* values of a reference target T₁ that correspond to certain input CMY values (for instance, C:10%, M:10%, and Y:10%) are L*₁, a*₁, and b*₁ and where colorimetric values (L*a*b* values of calorimetric result R₁) that correspond to the certain input CMY values obtained through color measurement of a calibration chart are L*₂, a*₂, and b*₂, color differences ΔL*₁₂, Δa*₁₂, and Δb*₁₂ are determined from Expressions (1) to (3):

ΔL*₁₂=L*₁−L*₂ (1)

Δa*₁₂=a*₁−a*₂ (2)

Δb*₁₂=b*₁−b*₂ (3)

The color differences ΔL*₁₂, Δa*₁₂, and Δb*₁₂ calculated as above are the errors of the colorimetric values.

The CPU 21 then calculates color values of a current target (Step S206). Specifically, the CPU 21 adds the errors of the colorimetric values calculated in Step S205 to L*a*b* values as color values of a present current target, and sets the result as a renewed current target. As shown in FIG. 10, for instance, the present current target is the reference target T₁ and its color values are L*₁, a*₁, and b*₁ in initial generation of the calibration curve. The errors of the colorimetric values calculated in Step S205 are ΔL*₁₂, Δa*₁₂, and Δb*₁₂. Thus, the color values L*₃, a*₃, and b*₃ of the renewed current target T₂ are calculated from Expressions (4) to (6):

L*₃=L*₁+ΔL*₁₂ (4)

a*₃=a*₁+Δa*₁₂ (5)

b*₃=b*₁+Δb*₁₂ (6)

Subsequently, the CPU 21 acquires CMY values corresponding to the color values of the current target with reference to the “L*a*b*-CMY LUT” of the correction profile 232 and sets the values as corrected CMY values (Step S207), and then executes the process of Step S201. Specifically, the CPU 21 calculates CMY values corresponding to the L*a*b* values of the renewed current target set in Step S206 by using the “L*a*b*-CMY LUT” of the correction profile 232 through interpolation calculation etc.

The CPU 21 repeats the processes of Steps S202 to S207 for tertiary colors to be measured whose CMY component values are 0%, 10%, 20%, 30%, 40%, 50%, 60%, 70%, 80%, 90%, and 100%, until all corrected CMY values are acquired. If the CPU 21 determines that all the corrected CMY values have been acquired (Step S201: Y), the CPU 21 generates a one-dimensional tertiary color correction curve (gray) where each of the CMY component values of a color to be measured is an input value, and where each of the corrected CMY values is an output value (Step S208). Then, the CPU 21 ends this process.

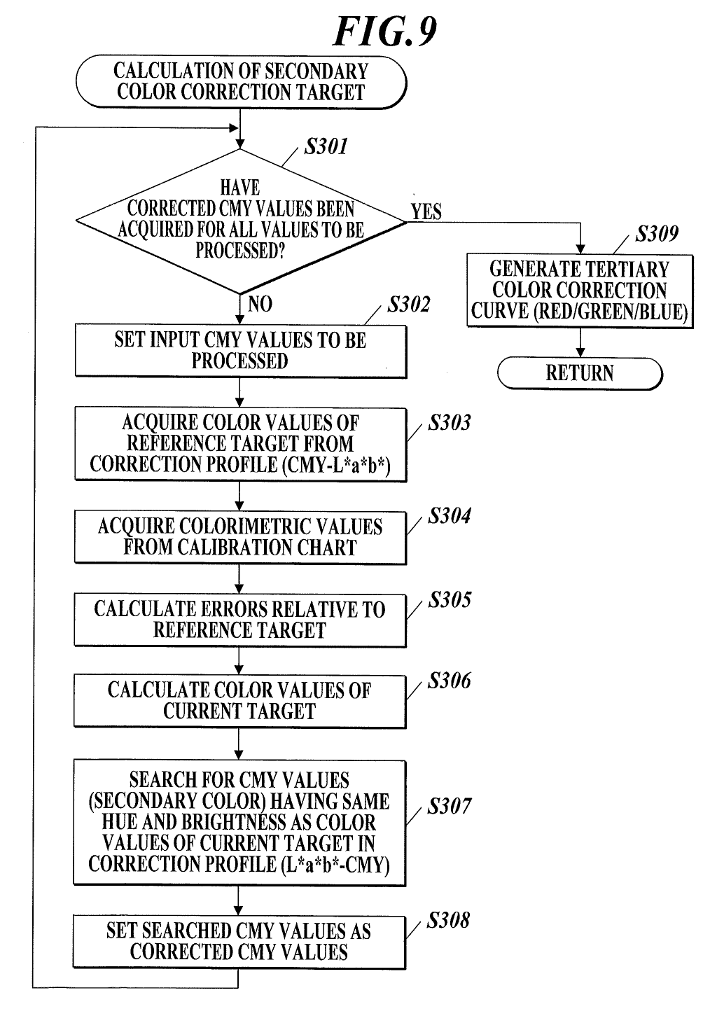

As shown in FIG. 7, after calculating the tertiary color correction target, the CPU 21 calculates a secondary color correction target (Step S102). The process of calculating the secondary color correction target is described below with reference to FIG. 9.

The CPU 21 determines whether all corrected CMY values of the secondary colors have been acquired (Step S301). Specifically, the CPU 21 determines whether the corrected MY values (C=0%) of R colors as secondary colors to be measured whose MY component values are 0%, 10%, 20%, 30%, 40%, 50%, 60%, 70%, 80%, 90%, and 100% (C is 0% for all) have been acquired; whether the corrected CY values (M=0%) of G colors as secondary colors to be measured whose CY component values are 0%, 10%, 20%, 30%, 40%, 50%, 60%, 70%, 80%, 90%, and 100% (M is 0% for all) have been acquired; and whether the corrected CM values (Y=0%) of B colors as secondary colors to be measured whose CM component values are 0%, 10%, 20%, 30%, 40%, 50%, 60%, 70%, 80%, 90%, and 100% (Y is 0% for all) have been acquired.

If the CPU 21 determines that not all the corrected CMY values of the secondary colors have been acquired (Step S301: N), the CPU 21 sets input CMY values to be processed (Step S302). Specifically, among the secondary colors to be measured whose MY component values are 0%, 10%, 20%, 30%, 40%, 50%, 60%, 70%, 80%, 90%, and 100%; whose CY component values are 0%, 10%, 20%, 30%, 40%, 50%, 60%, 70%, 80%, 90%, and 100%; and whose CM component values are 0%, 10%, 20%, 30%, 40%, 50%, 60%, 70%, 80%, 90%, and 100%, the CPU 21 sets any input MY values, input CY values, or input CM values for which no corresponding corrected MY values, CY values, or CM values are provided as values to be processed.

Referring to the “CMY-L*a*b* LUT” of the correction profile 232, the CPU 21 then acquires L*a*b* values corresponding to the input CMY values as color values of a reference target (Step S303). Based on the colorimetric values obtained through color measurement of the calibration chart as above, the CPU 21 acquires colorimetric values (L*a*b* values) corresponding to the input CMY values (Step S304).

Subsequently, the CPU 21 calculates errors of the colorimetric values relative to the color values of the reference target (Step S305). The CPU 21 then calculates color values of a current target (Step S306). Specific processes in Steps S305 and S306 are same as those in Steps S205 and S206, respectively, of calculation of the tertiary color correction target.

Then, the CPU 21 searches for CMY values having the same hue and brightness as the color values of the current target with reference to the “L*a*b*-CMY LUT” of the correction profile 232 (Step S307). Specifically, in the case of the color values of the current target corresponding to the R color, the CPU 21 sets the component value of the C color of CMY which does not compose the R color as 0%, and then searches for CMY values having the same hue and brightness. In the case of the color values of the current target corresponding to the G color, the CPU 21 sets the component value of the M color of CMY which does not compose the G color as 0%, and then searches for CMY values having the same hue and brightness. In the case of the color values of the current target corresponding to the B color, the CPU 21 sets the component value of the Y color of CMY which does not compose the B color as 0%, and then searches for CMY values having the same hue and brightness.

The CPU 21 sets the CMY values acquired as the results of the searches as the corrected CMY values (Step S308), and then executes the process of Step S301.

The CPU 21 repeats the processes of Steps S302 to S308 for secondary colors to be measured whose MY component values are 0%, 10%, 20%, 30%, 40%, 50%, 60%, 70%, 80%, 90%, and 100%; whose CY component values are 0%, 10%, 20%, 30%, 40%, 50%, 60%, 70%, 80%, 90%, and 100%; and whose CM component values are 0%, 10%, 20%, 30%, 40%, 50%, 60%, 70%, 80%, 90%, and 100%; until all corrected CMY values are acquired. If the CPU 21 determines that all the corrected CMY values have been acquired (Step S301: Y), the CPU 21 generates a secondary color correction curve (red), a secondary color correction curve (green), and a secondary color correction curve (blue), each being a one-dimensional curve, where each of the CMY component values of a color to be measured is an input value, and where each of the corrected CMY values is an output value (Step S309). Then, the CPU 21 ends this process.

As shown in FIG. 7, after calculating the secondary color correction target, the CPU 21 generates a primary color calibration curve (Step S103). Specifically, from the tertiary color correction curves and the secondary correction curves acquired in Steps S101 and S102, respectively, the CPU 21 reads out the corrected CMY values corresponding to the input CMY values used in generation of the correction curves and determines a corrected value for each of the CMY components.

To determine a correction value at C=10%, for instance, the CPU 21 selects the tertiary color correction curve (gray), the secondary color correction curve (green), and the secondary color correction curve (blue), each of which contains the C component, from the tertiary and secondary color correction curves. From these selected curves, the CPU 21 then extracts a C component value from each of the corrected CMY values that correspond to the input CMY values containing C=10%. Specifically, the CPU 21 extracts the C value (corrected C (gray)) of the corrected CMY values that correspond to the input CMY values containing C=10% from the tertiary color correction curve (gray), the C value (corrected C (green)) of the corrected CMY values that correspond to the input CMY values containing C=10% from the secondary color correction curve (green), and the C value (corrected C (blue)) of the corrected CMY values that correspond to the input CMY values containing C=10% from the secondary color correction curve (blue). Then, the CPU 21 weighted-averages the extracted C values using Expression (7) below to determine the corrected C value. In Expression (7), PC_{CMY}, PC_{CY}, and PC_{CM} each represent any proportional constant.

Corrected C=(PC_{CMY}*Corrected C (gray)+PC_{CY}*Corrected C (green)+PC_{CM}*Corrected C (blue))/(PC_{CMY}+PC_{CY}+PC_{CM}) (7)

In the embodiment, the proportional constant PC_{CMY} is 0.5 and the proportional constants PC_{CY} and PC_{CM} are each 0.25. Each proportional constant may be set to any value in view of a state of a printer, a color material, and a profile to be used. In this case, since the tertiary color is an important factor in color image printing, it is preferred that the proportional constant PC_{CMY} which corresponds to the tertiary color be set greater than the proportional constants which correspond to the respective secondary colors. This also applies to the case of determining corrected M and Y values hereinafter described.

The CPU 21 also determines corrected values for other C values (0%, 20%, 30%, 40%, 50%, 60%, 70%, 80%, 90%, and 100%) with the procedure above.

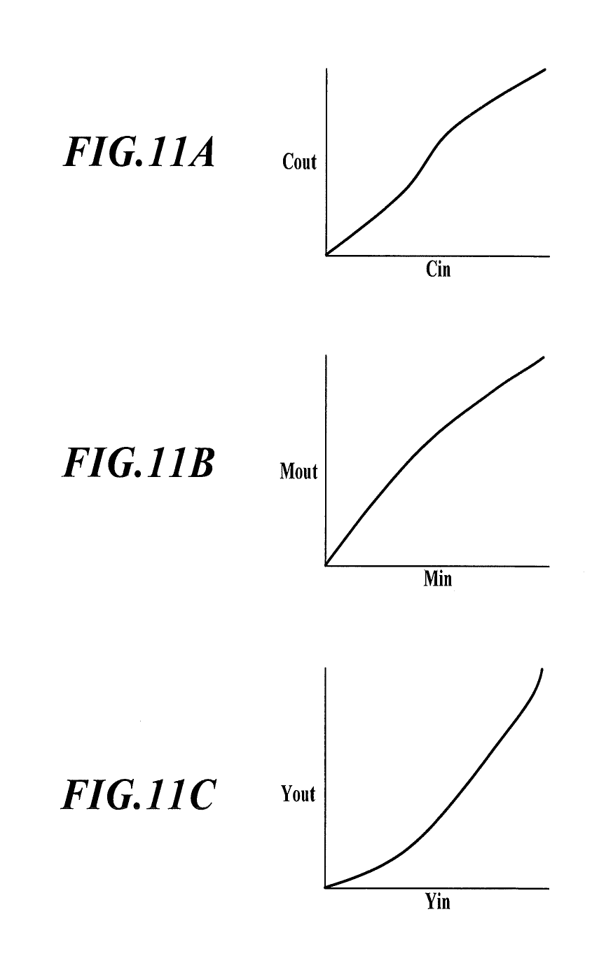

The CPU 21 then generates a primary color calibration curve of the C color, as shown in FIG. 11A, for instance, where the C value of the input CMY values is an input value and where the corrected C value determined as above is an output value.

Interpolating the corrected values determined as above allows increasing the number of input values and corrected values corresponding to the input values. That is, it is possible to determine a corrected value corresponding to an input value of, for instance, 15%.

To determine a correction value at M=10%, for instance, the CPU 21 selects the tertiary color correction curve (gray), the secondary color correction curve (red), and the secondary color correction curve (blue), each of which contains the M component, from the tertiary and secondary color correction curves. From these selected curves, the CPU 21 then extracts an M component value from each of the corrected CMY values that correspond to the input CMY values containing M=10%. Specifically, the CPU 21 extracts the M value (corrected M (gray)) of the corrected CMY values that correspond to the input CMY values containing M=10% from the tertiary color correction curve (gray), the M value (corrected M (red)) of the corrected CMY values that correspond to the input CMY values containing M=10% from the secondary color correction curve (red), and the M value (corrected M (blue)) of the corrected CMY values that correspond to the input CMY values containing M=10% from the secondary color correction curve (blue). Then, the CPU 21 weighted-averages the extracted M values using Expression (8) below to determine the corrected M value. In Expression (8), PC_{CMY}, PC_{MY}, and PC_{CM} each represent any proportional constant.

Corrected M=(PC_{CMY}*Corrected M (gray)+PC_{MY}*Corrected M (red)+PC_{CM}*Corrected M (blue))/(PC_{CMY}+PC_{MY}+PC_{CM}) (8)

In the embodiment, the proportional constant PC_{CMY} is 0.5 and the proportional constants PC_{MY} and PC_{CM} are each 0.25.

The CPU 21 also determines corrected values for other M values (0%, 20%, 30%, 40%, 50%, 60%, 70%, 80%, 90%, and 100%) with the procedure above.

The CPU 21 then generates a primary color calibration curve of the M color, as shown in FIG. 11B, for instance, where the M value of the input CMY values is an input value and where the corrected M value determined as above is an output value.

To determine a correction value at Y=10%, for instance, the CPU 21 selects the tertiary color correction curve (gray), the secondary color correction curve (red), and the secondary color correction curve (green), each of which contains the Y component, from the tertiary and secondary color correction curves. From these selected curves, the CPU 21 then extracts a Y component values from each of the corrected CMY values that correspond to the input CMY values containing Y=10%. Specifically, the CPU 21 extracts the Y value (corrected Y (gray)) of the corrected CMY values that correspond to the input CMY values containing Y=10% from the tertiary color correction curve (gray), the Y value (corrected Y (red)) of the corrected CMY values that correspond to the input CMY values containing Y=10% from the secondary color correction curve (red), and the Y value (corrected Y (green)) of the corrected CMY values that correspond to the input CMY values containing Y=10% from the secondary color correction curve (green). Then, the CPU 21 weighted-averages the extracted Y values using Expression below (9) to determine the corrected Y value. In Expression (9), PC_{CMY}, PC_{MY}, and PC_{CY} each represent any proportional constant.

Corrected Y=(PC_{CMY}*Corrected Y (gray)+PC_{MY}*Corrected Y (red)+PC_{CY}*Corrected Y (green))/(PC_{CMY}+PC_{MY}+PC_{CY}) (9)

In the embodiment, the proportional constant PC_{CMY} is 0.5 and the proportional constants PC_{MY} and PC_{CY} are each 0.25.

The CPU 21 also determines corrected values for other Y values (0%, 20%, 30%, 40%, 50%, 60%, 70%, 80%, 90%, and 100%) with the procedure above.

The CPU 21 then generates a primary color calibration curve of the Y color, as shown in FIG. 11C, for instance, where the Y value of the input CMY values is an input value and where the corrected Y value determined as above is an output value.

Subsequently, the CPU 21 generates a K correction calibration curve (Step S104) and ends this process. Specifically, based on K brightness (L* values) of 0% to 100% obtained through color measurement of K color patches, the CPU 21 performs interpolation calculation to determine corrected K values such that the brightness change of the corrected K values is the same as the brightness change of K=0% to 100% in the “CMYK-L*a*b* LUT” in the device profile. The corrected K values may be determined so as to match the change in reflective density, instead of the brightness change. The CPU 21 then generates a primary color calibration curve of the K color that provides corrected K values relative to input K values.

The primary color calibration curve for each of the corrected CMYK colors generated as above is stored in the memory 23 as a calibration curve 234.

With the calibration curve 234 configured as above, in the case, for example, where input points (grid points) of each calibration curve 234 are provided every 5% between 0% and 100% to calculate corrected CMYK values from input CMYK values, the corrected CMYK values can be acquired through interpolation calculation using the data of 21 points of each of the CMYK colors (i.e., 84 points in total). In the case of configuring a conventional correction table using a four-dimensional LUT, the number of grid points is 21×21×21×21=194,481 points. It is thus necessary to perform interpolation calculation using the data of 194,481 points to acquire corrected CMYK values. According to the embodiment, correction providing excellent color reproducibility can thus be performed based on data whose data size is approximately 1/2,300 of the data size of the conventional correction table.

In the embodiment, repeating the process of generating the calibration curve for multiple times gradually reduces errors and achieves more accurate correction even in the case where the color reproducibility of the printers 4a and 4b substantially varies from the color reproducibility represented in the device profile. The process of generating the calibration curve is repeated three times in the embodiment. The process may be repeated for any number of times. Generating the calibration curve can be terminated at the time when the variation error of each printer converges into a certain range.

During the repetition of generating the calibration curve in the embodiment, the tertiary and secondary correction curves are determined as below to reduce errors.

For instance, the primary color calibration curves for the respective primary colors generated as above are used to output the calibration chart shown in FIGS. 6A and 6B having undergone color conversion in each of the controllers 5a and 5b from the printers 4a and 4b, respectively, and to measure colors of color patches with the colorimeter 1.

Then, the calibration device 2 generates the tertiary and secondary correction curves based on the colorimetric results. Since color values of the current target are changed in generation of the calibration curves for the second time onwards (Step S206 in FIG. 8 and Step S306 in FIG. 9), errors between the color values of the reference target and the respective colorimetric values are added to color values different from the color values of the reference target set as the current target in generation of the first calibration curve.

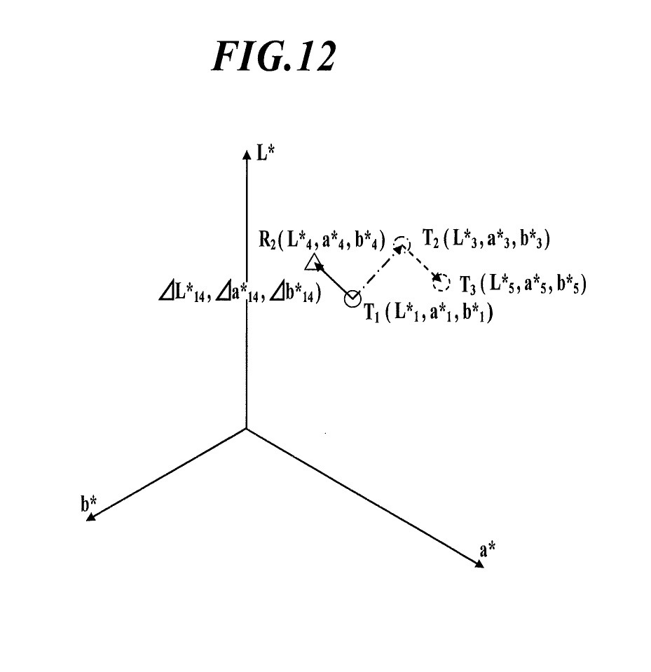

As shown in FIG. 12, for example, in the case where colorimetric values (L*a*b* values of colorimetric result R₂) that correspond to certain input CMY values obtained through color measurement of the calibration chart in the second generation of the correction curve are L*₄, a*₄, and b*₄, errors ΔL*₁₄, Δa*₁₄, and Δb*₁₄ relative to the reference target T₁ are determined from Expressions (10) to (12):

ΔL*₁₄=L*₁−L*₄ (10)

Δa*₁₄=a*₁−a*₄ (11)

Δb*₁₄=b*₁−b*₄ (12)

The color values of the current target are then calculated. In the second generation of the correction curve, the calculated errors are added to the color values L*₃, a*₃, and b*₃ of the current target T₂ set in the first generation of the correction curve as described above, and thereby color values of a renewed current target T₃ are calculated. Specifically, the color values L*₅, a*₅, and b*₅ of the renewed current target T₃ are calculated from Expressions (13) to (15):

L*₅=L*₃+ΔL*₁₄ (13)

a*₅=a*₃+Δa*₁₄ (14)

b*₅=b*₃+Δb*₁₄ (15)

Based on the color values of the calculated renewed current target T₃, the tertiary and secondary correction curves are generated as above. Generating the primary color calibration curves of the respective CMY colors on the basis of the correction curves provides calibration curves having reduced errors.

In the embodiment described above, the printers 4a and 4b each form a color image and output a calibration chart that includes color patches corresponding to input CMY values of secondary colors and tertiary colors, each of which colors composed of a combination of CMY reference colors. The colorimeter 1 measures colors of the color patches in the calibration chart output from each of the printers 4a and 4b and outputs colorimetric values in a colorimetric color space. The CPU 21 sets the correction profile 232 (target profile) that correlates combinations of the input CMY values of the secondary colors and the tertiary colors input to the printers 4a and 4b with target color values (L*a*b* values) in the colorimetric color space. The CPU 21 inputs the colorimetric values from the colorimeter 1. The CPU 21 calculates differences between the input colorimetric values and the respective target color values in the correction profile 232. Using the correction profile 232, the CPU 21 acquires, based on the calculated differences, corrected CMY values of the tertiary colors relative to the input CMY values of the tertiary colors and corrected CMY values of the secondary colors relative to the input CMY values of the secondary colors. The CPU 21 acquires color components for the respective reference colors based on the corrected CMY values of the tertiary colors and the corrected CMY values of the secondary colors. The CPU 21 calculates output CMY values (corrected C value, M value, and Y value) of the primary colors through predetermined weighted averaging of the acquired color components for the respective reference colors. Based on the calculated output CMY values of the primary colors, the CPU 21 generates the calibration curve 234 (primary color correction table) with which the input CMY values are corrected for each of the reference colors to determine the output CMY values relative to the input CMY values. Accordingly, the color correction, which does not use a multidimensional LUT, prevents an increase in processing load in color correction and takes into consideration both secondary and tertiary colors, thus enhancing color reproducibility.

Furthermore, the CPU 21 provides greater weighting in the weighted averaging of the color components acquired from the corrected CMY values of the tertiary colors than weighting of the color components acquired from the corrected CMY values of the secondary colors, thus achieving more excellent color reproducibility.

Furthermore, the CPU 21 acquires the corrected CMY values of the secondary colors and the tertiary colors relative to color values provided by adding the differences between the calculated colorimetric values and the target color values to the respective target color values, thus achieving more accurate color correction.

The description in the embodiment of the present invention is provided to merely illustrate an exemplary print system according to the present invention, but is not for limitation. Details in the configurations and operations of the functions included in the print system may be appropriately modified.

In the embodiment, the calibration device 2, the print instruction terminals 3a, 3b, and 3c, and the controllers 5a and 5b are provided as separate devices. Alternatively, one device may be configured to have the functions of the calibration device, the print instruction terminals, and the controllers. Further alternatively, these functions may be provided in the printers 4a and 4b.

Furthermore, a portion or the entirety of the functions of the calibration device 2 may be included in another device. A portion or the entirety of the functions of the print instruction terminals 3a, 3b, and 3c may be included in another device. A portion or the entirety of the functions of the controllers 5a and 5b may be included in another device.

In the embodiment, the input values and the output values respectively have a maximum value of 100% and are represented in values from 0% to 100%. Alternatively, the values may have a maximum value of 255, which is the maximum value of one byte, and may be represented in values from 0 to 255.

The embodiment of the present invention is applicable to a variety of color printers, including electrophotographic printers and ink-jet printers.

The calibration curve generated in the embodiment may be retained in any of a controller, a printer, a calibration device, and a print instruction terminal. The calibration curve, however, may more preferably be retained in either a controller or a printer.

In the embodiment, a hard disk drive or a semiconductor non-volatile memory is used as a computer-readable medium that stores programs according to the present invention. The medium, however, is not limited to such examples. Another example of such computer-readable medium may be a portable recording medium such as a CD-ROM. In addition, a carrier wave may also be applicable as a medium that provides data of the programs of the present invention through a communication cable.

The entire disclosure of Japanese Patent Application No. 2010-265866 filed on Nov. 30, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A calibration system comprising:
an image forming unit that forms a color image; and outputs a chart including a first patch corresponding to input CMY values of a tertiary color and a second patch corresponding to input CMY values of a secondary color, each of the tertiary color and the secondary color composed of a combination of CMY reference colors;
a color measuring unit that measures colors of the first and second patches in the chart output from the image forming unit and outputs colorimetric values in a colorimetric color space; and
a control unit that sets a target profile correlating a combination of the input CMY values of the tertiary color and a combination of the input CMY values of the secondary color input to the image forming unit, with respective target color values in the colorimetric color space; inputs the colorimetric values from the color measuring unit; calculates differences between the input colorimetric values and the respective target color values in the target profile; acquires, based on the calculated differences, corrected CMY values of the tertiary color relative to the input CMY values of the tertiary color and corrected CMY values of the secondary color relative to the input CMY values of the secondary color, using the target profile; acquires a first color component for a reference color based on the corrected CMY values of the tertiary color and a second color component for the reference color based on the corrected CMY values of the secondary color; calculates output CMY values of a primary color through predetermined weighted averaging of the acquired first color component and the acquired second color component, for each of the reference colors; and generates, based on the calculated output CMY values of the primary color, a primary color correction table with which the input CMY values are corrected for each of the reference colors to determine the output CMY values relative to the input CMY values, wherein
the image forming unit forms the color image based on the output CMY values determined by correcting the input CMY values using the primary color correction table generated by the control unit.

2. The calibration system according to claim 1, wherein the control unit gives greater weighting to the first color component acquired based on the corrected CMY values of the tertiary color than to the second color component acquired based on the corrected CMY values of the secondary color when performing the weighted averaging of the first and second color components.

3. The calibration system according to claim 1, wherein the control unit acquires the corrected CMY values of the tertiary color and the secondary color corresponding to color values acquired by adding the differences between the calculated colorimetric values and the respective target color values to the respective target color values.

4. A calibration method using an image forming apparatus that forms a color image, the method comprising:
(a) outputting, from the image forming apparatus, a chart including a first patch corresponding to input CMY values of a tertiary color and a second patch corresponding to input CMY values of a secondary color, each of the tertiary color and the secondary color composed of a combination of CMY reference colors; and measuring colors of the output first and second patches in the chart and acquiring colorimetric values in a colorimetric color space;
(b) setting a target profile correlating a combination of the input CMY values of the tertiary color and a combination of the input CMY values of the secondary color input to the image forming apparatus, with respective target color values in the colorimetric color space;
(c) calculating differences between the colorimetric values acquired in step (a) and the respective target color values in the target profile; and acquiring, based on the calculated differences, corrected CMY values of the tertiary color relative to the input CMY values of the tertiary color and corrected CMY values of the secondary color relative to the input CMY values of the secondary color, using the target profile;
(d) acquiring a first color component for a reference color based on the corrected CMY values of the tertiary color and a second color component for the reference color based on the corrected CMY values of the secondary color; and calculating output CMY values of a primary color through predetermined weighted averaging of the acquired first color component and the acquired second color component, for each of the reference colors;
(e) generating, based on the output CMY values of the primary color acquired in step (d), a primary color correction table with which the input CMY values are corrected for each of the reference colors to determine the output CMY values relative to the input CMY values; and
(f) forming the color image in the image forming apparatus based on the output CMY values determined by correcting the input CMY values using the primary color correction table.

5. The calibration method according to claim 4, wherein, in step (d), greater weighting is given to the first color component acquired based on the corrected CMY values of the tertiary color than to the second color component acquired based on the corrected CMY values of the secondary color when the weighted averaging of the first and second color components is performed.

6. The calibration method according to claim 4, wherein, in step (c), the corrected CMY values of the tertiary color and the secondary color are acquired, which corrected CMY values correspond to color values acquired by adding the differences between the calculated colorimetric values and the respective target color values to the respective target color values.

7. The calibration method according to claim 4, wherein, in step (a) after step (e), a third patch, whose input CMY values are corrected by using the primary color correction table, is formed in the chart to be output, and colorimetric values of the third patch are acquired; and steps (c), (d), and (e) are executed again based on the acquired colorimetric values of the third patch.

8. A recording medium that stores a program to cause a computer to function as:
an image forming unit that forms a color image; and outputs a chart including a first patch corresponding to input CMY values of a tertiary color and a second patch corresponding to input CMY values of a secondary color, each of the tertiary color and the secondary color composed of a combination of CMY reference colors;
a color measuring unit that measures colors of the first and second patches in the chart output from the image forming unit and outputs colorimetric values in a colorimetric color space; and
a control unit that sets a target profile correlating a combination of the input CMY values of the tertiary color and a combination of the input CMY values of the secondary color input to the image forming unit, with respective target color values in the colorimetric color space; inputs the colorimetric values from the color measuring unit; calculates differences between the input colorimetric values and the respective target color values in the target profile; acquires, based on the calculated differences, corrected CMY values of the tertiary color relative to the input CMY values of the tertiary color and corrected CMY values of the secondary color relative to the input CMY values of the secondary color, using the target profile; acquires a first color component for a reference color based on the corrected CMY values of the tertiary color and a second color component for the reference color based on the corrected CMY values of the secondary color; calculates output CMY values of a primary color through predetermined weighted averaging of the acquired first color component and the acquired second color component, for each of the reference colors; and generates, based on the calculated output CMY values of the primary color, a primary color correction table with which the input CMY values are corrected for each of the reference colors to determine the output CMY values relative to the input CMY values, wherein
the image forming unit forms the color image based on the output CMY values determined by correcting the input CMY values using the primary color correction table generated by the control unit.
